(19) United States
(12) Patent Application Publication
(10) Pub. No.: US 2026/0312295 A1
(43) Pub. Date: Oct. 8, 2026

(54) METASURFACE AND REFLECTING SYSTEM

(71) Applicant: NTT, Inc., Tokyo (JP)

(72) Inventors: Daisuke Kitayama, Tokyo (JP); Adam Pander, Tokyo (JP); Hiroyuki Takahashi, Tokyo (JP)

(21) Appl. No.: 19/480,463

(22) PCT Filed: May 29, 2023
(86) PCT No.: PCT/JP2023/019982

§ 371 Date: Oct. 31, 2025

(51) Int. Cl. H01Q 15/14; H01Q 15/00

(52) U.S. Cl. CPC H01Q 15/144; H01Q 15/0086; H01Q 15/148

(57) ABSTRACT

An embodiment is a metasurface including a first substrate, a plurality of resonant cells arranged on a first main surface of the first substrate, and a reflective film formed on a second main surface of the first substrate opposite to the first main surface. Each of the plurality of resonant cells includes a dielectric having a variable dielectric constant and a pair of metal patterns sandwiching the dielectric. Each of the plurality of resonant cells has a resonant frequency that changes according to the dielectric constant, and each of the plurality of resonant cells reflects electromagnetic waves having a frequency corresponding to the resonant frequency. The reflective film reflects electromagnetic waves that are not reflected by the plurality of resonant cells and that are transmitted through the first substrate.

### CROSS-REFERENCE TO RELATED APPLICATIONS

This application is a national phase entry of PCT Application No. PCT/JP2023/019982, filed on May 29, 2023, which application is hereby incorporated herein by reference.

### TECHNICAL FIELD

The present invention relates to a metasurface and a reflection system.

### BACKGROUND

As a type of metamaterial, a plate-shaped metasurface in which resonant cells are two-dimensionally arranged is known. As such a metasurface, Non Patent Literature 1 discloses a metasurface that uses a resonant cell in which a dielectric having a variable dielectric constant (a liquid crystal layer in Non Patent Literature 1) is sandwiched between opposing metal patterns.

### CITATION LIST

### Non Patent Literature

Non Patent Literature 1: Jun Yang, et al., “Electrically tunable liquid crystal terahertz device based on double-layer plasmonic metamaterial”, Optics Express, vol. 27, No. 19, pp. 27039-27045, 2019

### SUMMARY

### Technical Problem

Non Patent Literature 1 discloses a transmissive metasurface, but does not consider a reflective metasurface, and does not disclose adjusting a reflection phase distribution of electromagnetic waves in a specific frequency band.

An object of the present invention is to obtain a reflective metasurface that can adjust the reflection phase distribution of electromagnetic waves in a specific frequency band.

### Solution to Problem

In order to solve the above problems, a metasurface according to the present invention includes: a first substrate; a plurality of resonant cells arranged on a first main surface of the first substrate, each of the plurality of resonant cells including a dielectric having a variable dielectric constant and a pair of metal patterns sandwiching the dielectric, having a resonant frequency that changes according to the dielectric constant, and reflecting electromagnetic waves having a frequency corresponding to the resonant frequency; and a reflective film formed on a second main surface of the first substrate opposite to the first main surface, the reflective film reflecting electromagnetic waves that are not reflected by the plurality of resonant cells and that are transmitted through the first substrate.

A reflection system according to the present invention includes: the metasurface; and a control circuit that controls the dielectric constant for each of a predetermined number of resonant cells among the plurality of resonant cells and controls a phase distribution of electromagnetic waves in a specific frequency band reflected by the metasurface.

### Advantageous Effects of Invention

According to the present invention, a reflective metasurface is obtained that can adjust the reflection phase distribution of electromagnetic waves in a specific frequency band.

### BRIEF DESCRIPTION OF THE DRAWINGS

FIG. 1 is a configuration diagram illustrating a reflection system according to an embodiment of the present invention.

FIG. 2 is an enlarged view of portion A of a metasurface in FIG. 1 with the front substrate removed.

FIG. 3 is a cross-sectional view along line B-B of FIG. 2.

FIG. 4 is a plan view of a rear substrate, a part of a rear metal pattern layer, and a part of a rear wiring layer in FIG. 3, as viewed from the front side.

FIG. 5 is a plan view of a front substrate, a part of a front metal pattern layer, and a part of a front wiring layer in FIG. 3, as viewed from the rear side.

FIG. 6 is a conceptual diagram for describing a phase difference of electromagnetic waves reflected by a metasurface.

FIG. 7 is a graph showing frequency characteristics of a transmission intensity (S21 of S parameter) of electromagnetic waves of a resonant cell according to an embodiment of the present invention.

FIG. 8 is a graph showing frequency characteristics of a transmission intensity (S21 of S parameter) of electromagnetic waves of a resonant cell according to an embodiment of the present invention.

FIG. 9 is a graph showing frequency characteristics of a transmission intensity (S21 of S parameter) of electromagnetic waves according to a comparative example.

FIG. 10 is a graph showing frequency characteristics of a phase control amount of reflected waves of the metasurface of FIG. 1 for different thicknesses of a rear substrate 21.

FIG. 11 is a diagram illustrating a configuration of a pair of metal patterns that constitute a resonant cell according to a modification example.

FIG. 12 is a diagram illustrating a shape of a front metal pattern of the pair of metal patterns that constitute the resonant cell according to the modification example.

FIG. 13 is a diagram illustrating a shape of a rear metal pattern of the pair of metal patterns that constitute the resonant cell according to the modification example.

FIG. 14 is a graph showing frequency characteristics of the transmission intensity of electromagnetic waves for different interlayer distances according to the comparative example.

FIG. 15 is a schematic configuration diagram of a resonant cell according to a comparative example.

### DETAILED DESCRIPTION OF ILLUSTRATIVE EMBODIMENTS

Hereinafter, a reflection system 10 according to the present embodiment will be described with reference to the drawings. A thickness direction of a metasurface 20 and substrates 21 and 22, which will be described below, is referred to as a Z direction, and two directions that are orthogonal to the Z direction and orthogonal to each other are referred to as an X direction and a Y direction.

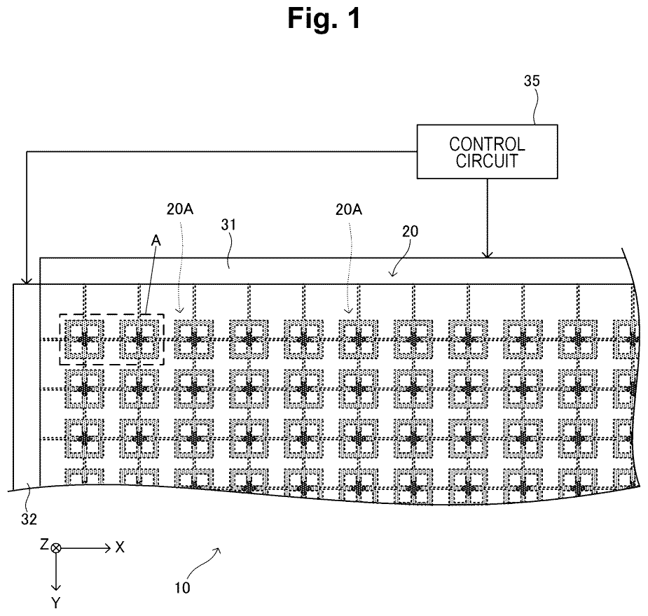

The reflection system 10 according to the present embodiment illustrated in FIG. 1 includes a metasurface 20 that reflects electromagnetic waves in a specific frequency band (for example, any frequency band in the range of 3 GHz to 3 THz) used as a carrier wave of information and has a variable reflection direction, drive circuits 31 and 32 that drive the metasurface 20 to control the reflection direction, and a control circuit 35 that controls the drive circuits 31 and 32.

The metasurface 20 is configured as a plate-shaped reflector that reflects electromagnetic waves in the above-mentioned specific frequency band. The metasurface 20 includes a plurality of resonant cells 20A arranged in a matrix in an XY direction. The resonant cell 20A will be described in detail later.

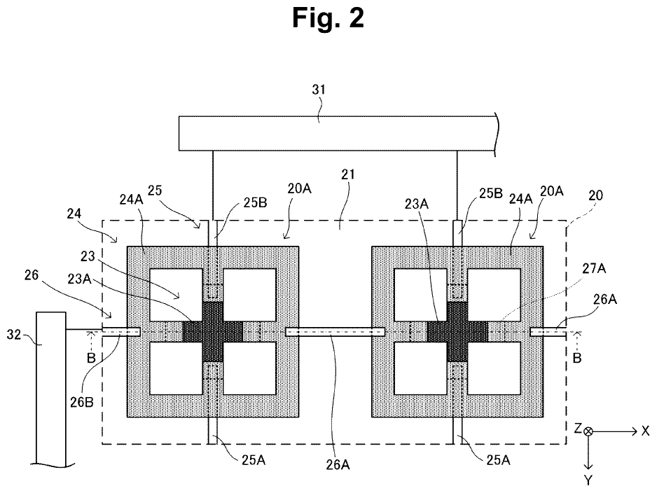

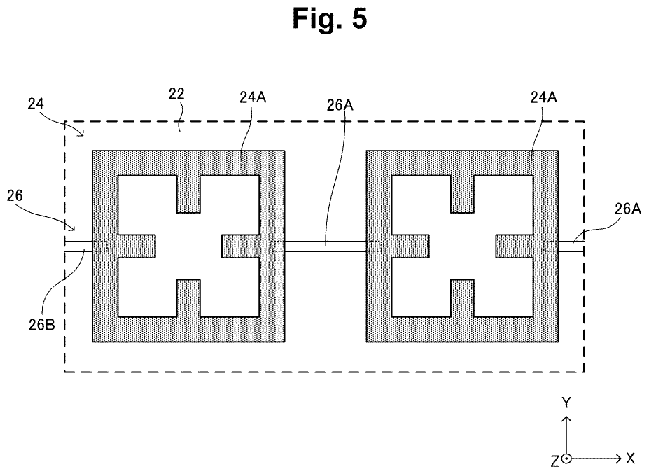

As illustrated in FIGS. 2 to 5, the metasurface 20 has a stacked structure including substrates 21 and 22, metal pattern layers 23 and 24, wiring layers 25 and 26, a dielectric layer 27, and a reflective film 28.

The substrate 21 and the substrate 22 face each other in the Z direction. The substrates 21 and 22 are insulating substrates made of a dielectric material such as a glass substrate. In addition, in the Z direction, the substrate 21 side is also called the front, and the substrate 22 side is also called the rear.

The metal pattern layer 23 is provided together with the wiring layer 25 on the front surface, which is the main surface of the substrate 21 facing the substrate 22. The metal pattern layer 24 is provided together with the wiring layer 26 on the rear surface, which is the main surface of the substrate 22 facing the substrate 21. The metal pattern layers 23 and 24 are formed from a conductive material such as copper.

The metal pattern layers 23 and 24 each include a plurality of metal patterns 23A and 24A arranged in a matrix in the XY direction. The plurality of metal patterns 23A and the plurality of metal patterns 24A face each other in the Z direction in a one-to-one relationship. A pair of metal patterns 23A and 24A constitute a resonant cell 20A.

The wiring layer 25 is made of a transparent electrode such as Indium Tin Oxide (ITO), and includes a plurality of wirings 25A and 25B extending in the Y direction. Each of the wirings 25A electrically connects two metal patterns 23A adjacent to each other in the Y direction. Each of the wirings 25B electrically connects the drive circuit 31 to each of the metal patterns 23A arranged in the X direction at the end in the Y direction.

The wiring layer 26 is made of a transparent electrode such as ITO, and includes a plurality of wirings 26A and 26B extending in the X direction. Each of the wirings 26A electrically connects two metal patterns 24A adjacent to each other in the X direction. Each of the wirings 26B electrically connects the drive circuit 32 to each of the metal patterns 24A arranged in the Y direction at the end in the X direction.

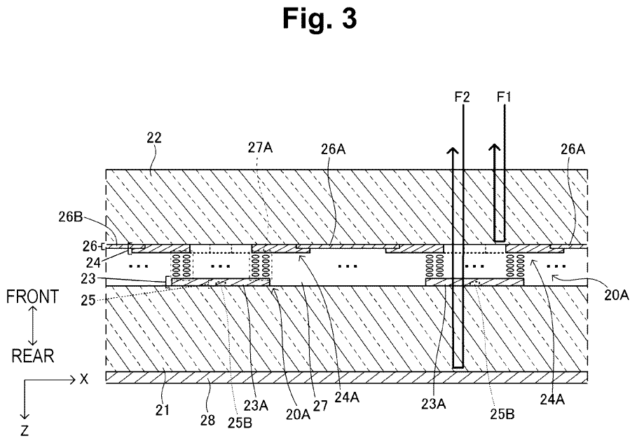

The dielectric layer 27 is sandwiched between the substrate 21 on which the metal pattern layer 23 and the wiring layer 25 are provided, and the substrate 22 on which the metal pattern layer 24 and the wiring layer 26 are provided. The dielectric layer 27 has a variable dielectric constant. Here, the dielectric constant changes depending on the applied voltage. The dielectric layer 27 is made of liquid crystal, and is enclosed between the substrate 21 and the substrate 22, and is sealed with a sealing member (not illustrated). In FIG. 3, the dielectric layer 27 is illustrated by a diagram in which some liquid crystal molecules are schematically exaggerated.

The reflective film 28 is formed on the main surface of the substrate 21 opposite to the substrate 22 side, and is configured to reflect electromagnetic waves that have transmitted through the substrate 21 and the like. The reflective film 28 is made of a metal film or a transparent conductive film formed of ITO or the like.

In the present embodiment, each resonant cell 20A includes a pair of metal patterns 23A and 24A facing each other in the Z direction, and a dielectric 27A that is a portion of the dielectric layer 27 sandwiched between the metal patterns 23A and 24A. The pair of metal patterns 23A and 24A are formed in different shapes and are formed in a shape in which parts of the pair of metal patterns 23A and 24A overlap when viewed from the Z direction. The dielectric 27A is a portion sandwiched between the overlapping portions of the metal patterns 23A and 24A. Each of the pair of metal patterns 23A and 24A does not have a resonant structure, but the combination of the metal patterns 23A and 24A forms a single resonant structure.

The resonant structure of the resonant cell 20A is an LC resonant structure having an inductive component L[H] and a capacitive component C[F], and reflects electromagnetic waves in a frequency band including a resonant frequency fr corresponding to the component LC and frequencies nearby it (see F1 in FIG. 3). The resonant frequency fr is derived from the following Equation (1).

$$fr = 1 / ( 2 π √ ( L \cdot C ) ) \qquad ( 1 )$$

The inductive component L is a fixed value resulting from the shapes of the metal patterns 23A and 24A. On the other hand, the capacitive component C changes according to the dielectric constant of the dielectric 27A sandwiched between the overlapping portions of the metal patterns 23A and 24A. The dielectric constant changes according to the potential difference between the pair of metal patterns 23A and 24A, that is, the applied voltage. The applied voltage is applied by drive circuits 31 and 32.

The drive circuit 31 supplies an arbitrary potential via the wiring layer 25 to all the metal patterns 23A individually for each row aligned in the X direction. The drive circuit 32 supplies an arbitrary potential via the wiring layer 26 to all the metal patterns 24A individually for each column aligned in the Y direction.

The drive circuits 31 and 32 are controlled by the control circuit 35. The control circuit 35 controls the supply potentials for each of the columns and rows via the drive circuits 31 and 32. Accordingly, the potential difference between the metal patterns 23A and 24A, that is, the applied voltage, is controlled for each resonant cell 20A, and this makes it possible to change the dielectric constant of the dielectric 27A, that is, the resonant frequency fr, for each resonant cell 20A. The control circuit 35 is composed of an application specific integrated circuit (ASIC), a field-programmable gate array (FPGA), or a computer that executes a program.

Of the electromagnetic waves transmitted through the substrate 21 from the front, the resonant cell 20A reflects electromagnetic waves having its own resonant frequency fr and in a frequency band nearby the resonant frequency fr, and transmits other electromagnetic waves. The transmitted electromagnetic wave is reflected by the reflective film 28 (see F2 in FIG. 3). As described above, since the resonant frequency fr of the resonant cell 20A is variable, the proportion of the electromagnetic waves in the above-mentioned specific frequency band reflected by the metasurface 20 that are reflected by the resonant cell 20A and the proportion that are reflected by the reflective film 28 can be changed. By bringing the resonant frequency fr closer to the center frequency of the specific frequency band, the proportion of electromagnetic waves in the specific frequency band reflected by the resonant cell 20A increases. Conversely, by moving the resonant frequency fr away from the center frequency of the specific frequency band, the proportion of electromagnetic waves in the specific frequency band reflected by the reflective film 28 increases. By controlling such a reflection proportion for each of a predetermined number (including one) of resonant cells 20A, the phase of the reflected wave in a specific frequency band can be controlled for each of the predetermined number of resonant cells 20A. That is, the phase distribution of the reflected wave for each of a predetermined number of resonant cells 20A is adjusted. The reflection proportion may be a binary value of 0% or 100%. That is, the control of the reflection proportion is a concept including binary control of whether the electromagnetic wave is reflected by either the resonant cell 20A or the reflective film 28. By adjusting the phase distribution of the reflected wave, electromagnetic waves in a specific frequency band can be reflected in any direction.

For example, the control circuit 35 refers to voltage data, such as a table, that defines an applied voltage to each of the resonant cells 20A, and applies the applied voltage defined by the voltage data to each of the resonant cells 20A. It is assumed that the voltage data is obtained by experiment, simulation, or the like, and stored in the control circuit 35 in advance. The voltage data is prepared for the number of directions in which electromagnetic waves are desired to be reflected. The control circuit 35, for example, externally acquires position information of a moving object (such as a mobile phone or an automobile) to which a reflected wave is to be directed, and selects and refers to voltage data corresponding to the acquired position information. Accordingly, the control circuit 35 can dynamically adjust the phase distribution, and can cause the reflection direction of the electromagnetic wave in the specific frequency band to follow the moving object. The control circuit 35 may use only one piece of voltage data. In other words, the control circuit 35 may adjust the phase distribution of the reflected wave in a specific frequency band from the phase distribution in the initial state in which no voltage is applied to the phase distribution in which a voltage is applied. The adjustment of the phase distribution includes changing the phase distribution from an unused state in which no voltage is applied to a phase distribution in which a voltage is applied and in which the device is in use.

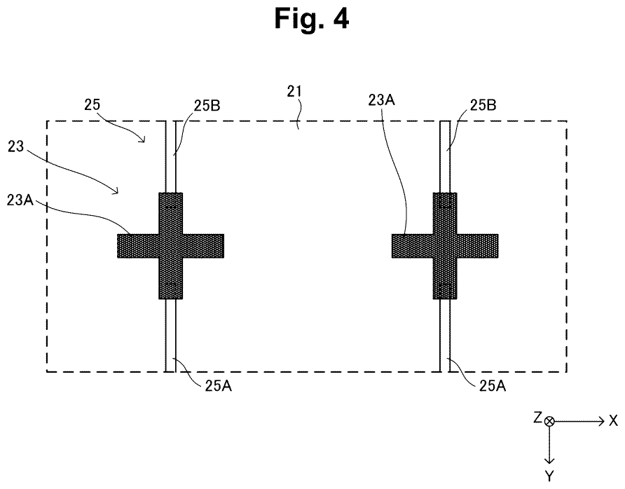

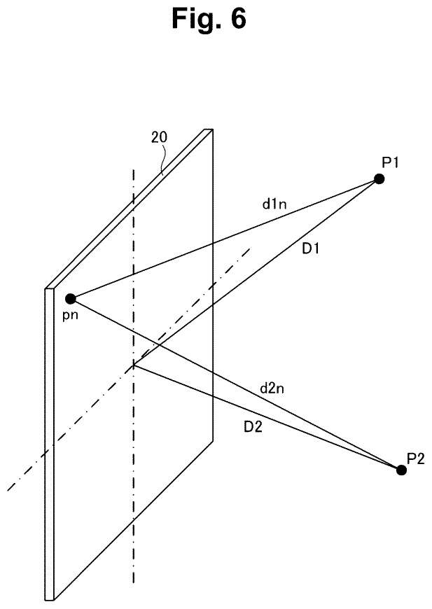

For example, as illustrated in FIG. 6, a wave source of an electromagnetic wave in a specific frequency band directed to the metasurface 20 is denoted as P1, and a position at which the electromagnetic wave is to be reflected via the metasurface 20 is denoted as P2. For each of the N resonant cells 20A that constitute the metasurface 20, the position of the nth resonant cell 20A is denoted as pn (n is an integer from 1 to N), the distance from P1 to an arbitrary reference point on the metasurface 20 (which is the center of the substrate in FIG. 4) is denoted as D1, the distance from P2 to the reference point is denoted as D2, the distance from P1 to pn is denoted as din, and the distance from P2 to Pn is denoted as dan. The phase difference Gn associated with the difference in propagation path length of the electromagnetic wave due to the unit cell is expressed by the following Equation (2).

$$Gn = 2 π ( ( d 1 n - D 1 ) + ( d 2 n - D 2 ) ) / λ \qquad ( 2 )$$

The positions of pn and the reference point in the thickness direction (Z direction) of the metasurface 20 may be any fixed positions. For example, when the wavelength of the electromagnetic wave in a specific wavelength band is sufficiently long compared to the thickness of the metasurface 20, the fixed position can be set.

The applied voltage of each resonant cell 20A, which is defined by the above voltage data, is determined so as to reduce the phase difference Gn for that resonant cell 20A, and to direct the electromagnetic waves in the specific frequency band as a whole toward the position P2.

In the case of the above-mentioned binary control, the applied voltage of each resonant cell 20A may be determined such that, for example, the reflection phase of the resonant cell 20A at a position where the remainder when the phase difference Gn is divided by 2π is 0 or more and less than π is 0, and the reflection phase of the resonant cell 20A at a position where the remainder is a or more and less than 2π is π. The reflection phase of the former may be set to π, and the reflection phase of the latter may be set to 0. In the above, “the remainder is 0 or more and less than π” may be changed to “the remainder is 0 or more and less than π/2 and 2π/3 or more and less than 2π”, and “the remainder is π or more and less than 2π” may be changed to “the remainder is π/2 or more and less than 2π/3”.

In a case where D1 is set to be sufficiently large compared to the size of the metasurface 20, a reflection phase distribution can be determined assuming a plane wave arriving from the direction of P1. By setting D2 to be sufficiently large compared to the size of the metasurface 20, the function of directing the reflected wave toward P2 is realized.

In the present embodiment, at least a part of the wirings in the wiring layers 25 and 26 may have a component parallel to the electric field component of the electromagnetic wave in a specific frequency band, regardless of the polarization direction of the electromagnetic wave. Such a phenomenon occurs, for example, when the wirings are arranged in a matrix. A wiring having a component parallel to the electric field component of the electromagnetic wave inhibits coupling between the resonant structure of the resonant cell 20A and the electromagnetic wave, making it impossible to obtain the intended reflection phase distribution. The wiring layers 25 and 26 are preferably formed of a conductive material having a higher resistance than the material from which the metal pattern layers 23 and 24 are formed. Accordingly, electromagnetic waves (particularly millimeter waves to terahertz waves) mainly couple with the resonant cell 20A formed of a low-resistance material, and are less likely to couple with the high-resistance wiring layers 25 and 26, and therefore the wiring layers 25 and 26 do not interfere and a desired reflection phase distribution can be obtained. An example of a low-resistance conductive material is copper, and an example of a high-resistance conductive material is ITO. As the low-resistance conductive material, low-resistance ITO may be used.

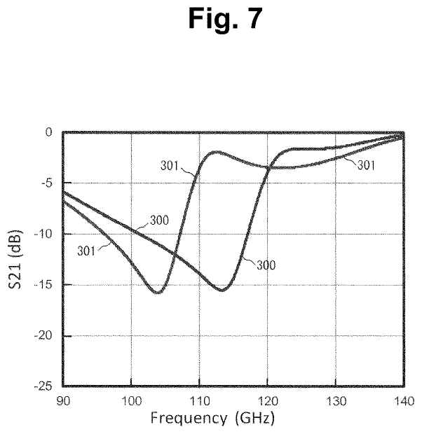

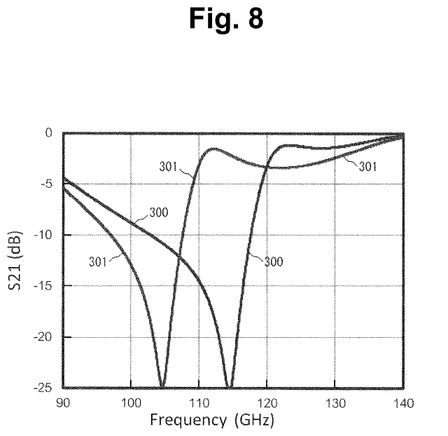

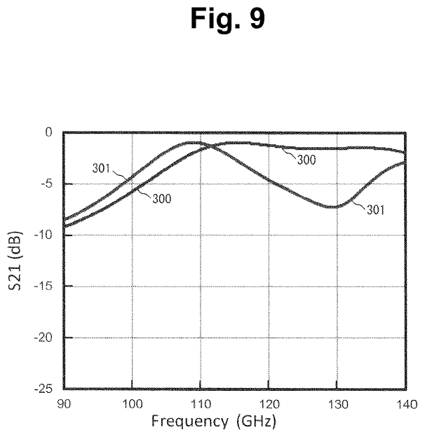

FIG. 7 shows the results of calculations performed by electromagnetic field analysis simulation of the electromagnetic wave transmission intensity characteristics of one resonant cell 20A when the metal patterns 23A and 24A constituting the resonant cell 20A are made of copper and the wirings 25A and 25B, the wiring 26A, and the wiring 26B are made of ITO. Here, non-alkali glass is used for the substrates 21 and 22, and liquid crystal having a relative dielectric constant er of 2.5 to 3.5 depending on the applied voltage is used. In addition, the reflective film 28 is omitted here in order to observe the transmission intensity of the electromagnetic wave. In addition, FIGS. 8 and 9 show calculation results of a comparative example. FIG. 8 shows the calculation results of a comparative example in which all wiring such as the wiring 25A is not provided, and FIG. 9 shows the calculation results of a comparative example in which the wiring 25A and the like are formed of copper like the metal pattern 23A and the like.

The vertical axis in FIG. 7 to FIG. 9 represents an intensity (S21) of the electromagnetic wave transmitted through the resonant cell 20A, that is, the transmitted wave. FIG. 7 to FIG. 9, 300 indicates the characteristics in a case where the relative dielectric constant Er of the dielectric layer 27 (particularly, the dielectric 27A) is 2.5, and 301 indicates the characteristics in a case where the relative dielectric constant er is 3.5.

FIG. 8 shows the characteristics in a case where there is no wiring, and thus shows two transmitted wave intensity characteristics when the material of the dielectric layer 27 is changed to change the relative dielectric constant. As shown in FIG. 9, in a case where the wiring 25A and the like are formed of the same copper as the metal pattern 23A and the like, the transmitted wave intensity characteristics do not change significantly even if the relative dielectric constant er of the dielectric layer 27 is changed by the applied voltage, and it is found that the controllability is poor. In contrast, as shown in FIG. 7, in a case where the wiring 25A and the like are formed using high-resistance ITO as a material, the transmitted wave intensity characteristics change significantly due to the change in the relative dielectric constant & of the dielectric layer 27. In this way, by making the wiring 25A and the like have a higher resistance than the metal pattern 23A and the like of the resonant cell 20A, it is possible to effectively change the frequency of the transmitted wave.

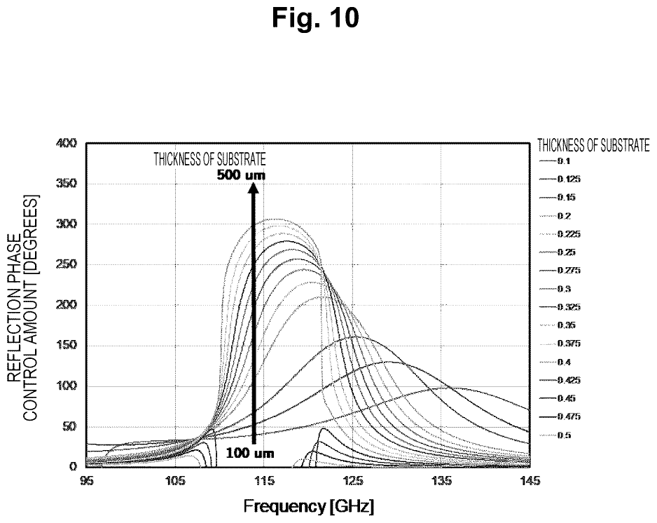

FIG. 10 shows the results of calculations, by electromagnetic field simulation, of reflection phase characteristics when a copper reflective film 28 is formed on the configuration of FIG. 7. In this simulation, the thickness of the substrate 21 is changed. It can be seen that as the thickness of the substrate 21 increases from 100 μm to 500 μm, the reflection phase control amount, which is the phase difference between the electromagnetic wave reflected by the resonant cell 20A and the electromagnetic wave reflected by the reflective film 28, increases. This is because the path length of the wave reflected by the reflective film 28 is longer than that of the wave reflected by the resonant cell 20A. From these results, for example, in the case of forming a reflection phase distribution with a phase quantization bit number of 1 bit, a phase control amount of 180 degrees is sufficient, so that the thickness of the substrate 21 may be set to 200 μm or more. In the case of 3 bits, the thickness may be set to 200 μm or more to achieve a phase control amount of 270 degrees, and in the case of 3 bits, the thickness may be set to 500 μm or more to achieve a phase control amount of 315 degrees.

As described above, the metasurface 20 according to the present embodiment includes the substrate 21 and the plurality of resonant cells 20A arranged on the main surface of the substrate 21. Each of the plurality of resonant cells 20A includes the dielectric 27A having a variable dielectric constant and the pair of metal patterns 23A and 24A sandwiching the dielectric 27A, has a resonant frequency that changes according to the dielectric constant, and reflects electromagnetic waves having a frequency corresponding to the resonant frequency (here, the resonant frequency and a frequency band nearby it). The reflective film 28 is formed on the main surface of the substrate 21 opposite to the main surface, which reflects electromagnetic waves that are not reflected by the plurality of resonant cells 20A and that are transmitted through the substrate 21. With this configuration, since the resonant frequency fr of each resonant cell 20A is variable, it is possible to change the reflection proportion as to whether electromagnetic waves in a specific frequency band reflected by the metasurface 20 is reflected by the resonant cell 20A or reflected by the reflective film 28, whereby the phase distribution of the reflected waves of electromagnetic waves in a specific frequency band can be adjusted. The purpose of adjusting the phase distribution is arbitrary, but for example, as described above, it becomes possible to control the reflection direction of electromagnetic waves in a specific frequency band.

In the above embodiment, the control circuit 35 controls the dielectric constant of the dielectric 27A for each of a predetermined number of resonant cells 20A among the plurality of resonant cells 20A, and controls the phase distribution of the electromagnetic wave in a specific frequency band reflected by the metasurface 20, thereby easily adjusting the phase distribution. The control algorithm is not limited to the above, and any suitable algorithm may be set.

As described above, the pair of metal patterns 23A and 24A are formed in a shape in which parts of the pair of metal patterns 23A and 24A overlap when viewed from the thickness direction of the substrate 21, that is, the Z direction, the dielectric 27A is sandwiched between the overlapping parts of the pair of metal patterns 23A and 24A, and the pair of metal patterns 23A and 24A and the dielectric 27A form a single resonant structure in which the part constitutes the capacitive component C. With this configuration, the dielectric 27A, that is, the dielectric layer 27 of the resonant cell 20A can be made thin, and the thickness of the dielectric layer 27 can be made the same as that of the liquid crystal layer of a liquid crystal display device (5 μm). Instead of the above-mentioned structure, a structure in which each of a pair of metal patterns is individually formed into a resonant structure may also be used. However, the former results in a thinner metasurface 20 (this will be described later). As the shape in which parts of a pair of metal patterns overlap when viewed from the Z direction, in addition to the shape in which parts of the pair of metal patterns overlap as described above, a shape in which one of the pair of metal patterns completely overlaps the other may be employed.

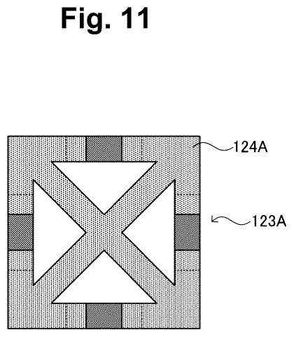

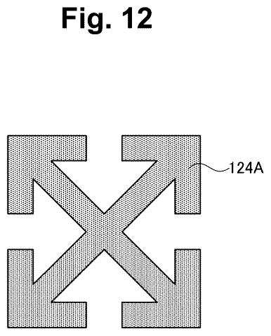

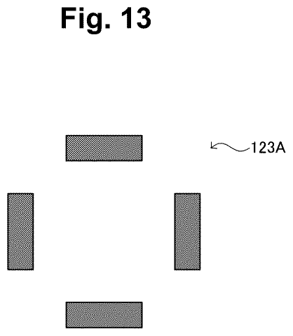

The pair of metal patterns constituting a single resonant structure may have any shape. For example, the pair of metal patterns may have the shapes illustrated in FIGS. 11 to 13. A metal pattern 123A in FIG. 11 may be provided in place of the metal pattern 23A, and a metal pattern 124A in FIG. 11 may be provided in place of the metal pattern 24A. The pair of metal patterns may have a four-fold rotationally symmetrical structure as illustrated in FIG. 2 and FIG. 11 so that the resonant cell operates regardless of the polarization of the incoming electromagnetic wave, but may have other shapes. The pair of metal patterns are formed, for example, in a shape that forms a plurality of annular portions when viewed from the Z direction, which cannot be formed by each of the metal patterns.

The dielectric layer 27 may be made of any material whose dielectric constant can be changed. If it is a liquid crystal layer as described above, the dielectric constant can be controlled by active matrix control or the like of the liquid crystal display device, making such control easy. Furthermore, by providing the substrate 22 opposite to the substrate 21, a liquid crystal layer can be sealed between the substrates 21 and 22, which makes it possible to hold the liquid crystal layer. An alignment layer for aligning liquid crystal molecules may be provided in at least one between the metal pattern layer 23 and the dielectric layer 27 made of liquid crystal, and between the metal pattern layer 24 and the dielectric layer 27 made of liquid crystal. In other words, the metal patterns 23A and 24A may sandwich the dielectric 27A via another layer, such as an alignment layer. In a case where the dielectric layer 27 is solid, the substrate 22 may be omitted and a metal pattern layer 24 or the like may be provided on the front surface of the dielectric layer 27.

The material of the substrates 21 and 22 may be a dielectric or the like. The substrates 21 and 22 may be transparent substrates such as glass substrates, and the reflective film 28 may be a transparent film (for example, low-resistance ITO) or a mesh-shaped metal film that transmits visible light. This results in a metasurface 20 that is transmissive to visible light. Taking this into consideration, it is preferable that the metal pattern layers 23 and 24 and the wiring layers 25 and 26 be also made of a transparent conductor such as ITO. This results in a light-transmitting metasurface 20 that can be installed on windows of buildings, vehicles, and the like.

As described above, the wiring layers 25 and 26, such as the wirings 25A and 26A connected to the pair of metal patterns 23A and 24A, may be made of a material having a higher resistance than each of the pair of metal patterns. Accordingly, even if the metasurface 20 has the wiring 25A or 26A or the like having a component parallel to the electric field component of the electromagnetic waves, the electromagnetic waves (particularly millimeter waves to terahertz waves) mainly couple with the resonant cell 20A formed of a low-resistance material, and do not couple with the high-resistance wiring layers 25 and 26, and therefore a desired reflection phase distribution can be obtained.

As described above, the resonant cell 20A may include a pair of metal patterns, each of which serves as an independent resonator, instead of the metal patterns 23A and 24A constituting a single resonant structure. An example of the latter is a pair of metal patterns of the same resonant shape. However, this shape makes it difficult to make it thinner. This point will be described below.

In a case where a pair of independent resonators sandwiching the dielectric 27A, that is, a two-layer resonator, is employed, as the resonant modes excited by an external electric field due to electromagnetic waves, in the two-layer resonator, an antisymmetric mode in which opposite-phase currents are excited, and a symmetric mode in which the same-phase currents are excited occur. The antisymmetric mode is a resonant mode in which the attractive Coulomb force between layers due to excited charges is large, while the symmetric mode is a resonant mode in which the repulsive Coulomb force between layers due to excited charges is large. Therefore, the antisymmetric mode occurs on the lower energy, that is, lower frequency, side than the symmetric mode.

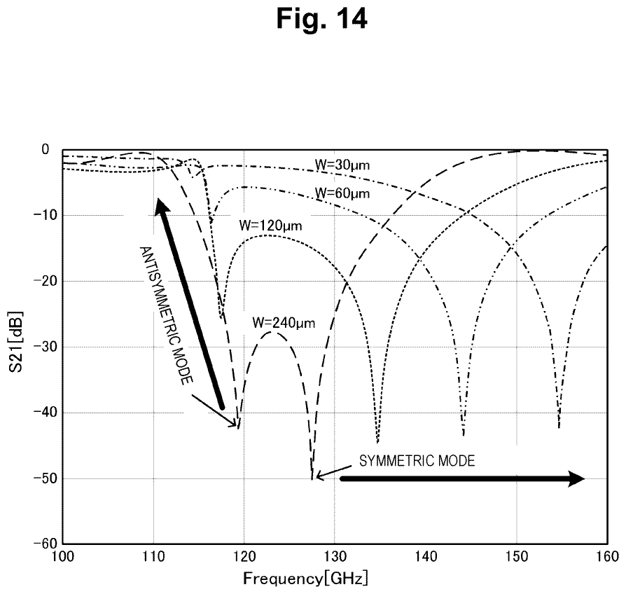

The resonant frequencies of these two resonant modes change according to the distance between the resonators (hereinafter referred to as an interlayer distance W). The shorter the interlayer distance W, the greater the frequency difference between the two modes. Furthermore, the antisymmetric mode, in which currents of opposite phase are excited, has a smaller resonant peak. The termination of the electric field lines between the layers occurs in an antisymmetric mode in which an attractive Coulomb force occurs between the layers, and therefore, it is in the antisymmetric mode that a larger change in resonant characteristics can be obtained by changing the dielectric constant of the dielectric layer. Furthermore, in the case of considering use as a resonant cell of a metasurface, it is desirable to use a resonant cell structure that is smaller than the wavelength in order to form a planar phase distribution as a continuous distribution, and for this purpose, it is appropriate to utilize the antisymmetric mode that occurs on the low frequency side. However, in the millimeter wave and terahertz wave bands, the use of which is being discussed for 6G and the like, if the interlayer distance W is set to about 5 μm, the same as in general optical displays, the resonant peak becomes so small that it cannot be observed (see FIG. 14; at 30 μm, no resonant peak can be obtained). In other words, the change in resonant frequency due to the change in dielectric constant becomes small. On the other hand, if a pair of metal patterns constitutes a single resonant structure as in the above embodiment, a clear resonant peak as shown in FIG. 7 can be obtained even in the antisymmetric mode in which the interlayer distance W is made thin. Therefore, the resonant frequency fr can be made to vary significantly by changing the dielectric constant, making it easier to control the transmission and reflection of electromagnetic waves.

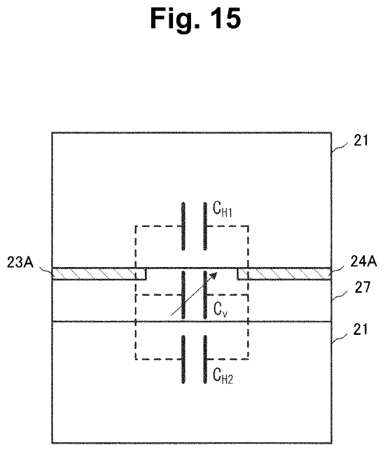

Furthermore, the metal patterns 23A and 24A constituting a single resonant structure may be provided on the same plane instead of sandwiching the dielectric 27A (FIG. 15). In this case, the capacitive component of the resonant cell is constituted by a parallel connection of capacitances C_{H1} and C_{H2} formed via the substrates 21 and 22, whose dielectric constant does not change, and a capacitance C_{V}, whose dielectric constant changes. In this case, the resonant frequency is fr=½π√(L·(C_{H1}+CH2+C_{V})), and the change in resonant frequency due to the change in C_{V} is inhibited by C_{H1}+C_{H2}. On the other hand, in the case of the above configuration in which the dielectric 27A is sandwiched, the resonant frequency fr is as shown in the above Equation (1), and the change in resonant frequency due to the change in the dielectric constant of the dielectric 27A is larger than the case where the capacitive component is formed of a metal on the same plane. This makes it possible to obtain a large change in the resonant frequency even if the thickness of the dielectric 27A is thin.

As described above, by using a pair of metal patterns that constitute a single resonant structure, such as the above-mentioned metal patterns 23A and 24A, the change in resonant frequency with respect to the change in dielectric constant can be increased even if the dielectric is made thin, and the metasurface 20 can be made thin, thereby achieving a thickness similar to that of a liquid crystal display panel or the like. This allows for lower drive voltages and faster response times, and makes the manufacture of metasurface 20 compatible with existing optical display manufacturing processes.

The present invention is not limited to the above embodiments and modification examples. For example, the present invention includes various modifications to the above-described embodiments and modification examples that can be understood by those skilled in the art within the scope of the technical idea of the present invention. The configurations described in the above-described embodiments and modification examples can be appropriately combined without being inconsistent. In addition, it is also possible to delete an arbitrary configuration among the above-described configurations.

### (Supplementary Notes)

A configuration exemplifying the above embodiment and modification examples will be described below.

### (Supplementary Note 1)

A metasurface including:
a first substrate;
a plurality of resonant cells arranged on a first main surface of the first substrate, each of the plurality of resonant cells including a dielectric having a variable dielectric constant and a pair of metal patterns sandwiching the dielectric, having a resonant frequency that changes according to the dielectric constant, and reflecting electromagnetic waves having a frequency corresponding to the resonant frequency; and
a reflective film formed on a second main surface of the first substrate opposite to the first main surface, the reflective film reflecting electromagnetic waves that are not reflected by the plurality of resonant cells and that are transmitted through the first substrate.

### (Supplementary Note 2)

The metasurface according to Supplementary Note 1,
in which the pair of metal patterns are formed in a shape in which parts of the pair of metal patterns overlap when viewed from a thickness direction of the first substrate,
the dielectric is sandwiched between the overlapping parts of the pair of metal patterns, and
the pair of metal patterns and the dielectric form a single resonant structure in which the part constitutes a capacitive component.

### (Supplementary Note 3)

The metasurface according to Supplementary Note 1 or 2, further including a second substrate facing the first main surface of the first substrate and having one of the pair of metal patterns formed on a surface facing the first main surface,
in which the other of the metal patterns is formed on the first main surface, and
the dielectric is a part of a liquid crystal layer sealed between the first substrate and the second substrate.

### (Supplementary Note 4)

The metasurface according to Supplementary Note 3,
in which the first substrate and the second substrate are transparent,
and the reflective film is formed in a transparent or mesh shape.

### (Supplementary Note 5)

The metasurface according to any one of Supplementary Notes 1 to 4, further including:
a first wiring connected to one of the pair of metal patterns, and
a second wiring connected to the other of the pair of metal patterns,
in which the first wiring and the second wiring are formed of a material having a higher resistance than each of the pair of metal patterns.

### (Supplementary Note 6)

A reflection system including:
the metasurface according to any one of Supplementary Notes 1 to 5; and
a control circuit that controls the dielectric constant for each of a predetermined number of resonant cells among the plurality of resonant cells and controls a phase distribution of electromagnetic waves in a specific frequency band reflected by the metasurface.

### REFERENCE SIGNS LIST

10 Reflection system
20 Metasurface
20A Resonant cell
21 Substrate
22 Substrate
23 Metal pattern layer
23A Metal pattern
24 Metal pattern layer
24A Metal pattern
25 Wiring layer
25A Wiring
25B Wiring
26 Wiring layer
26A Wiring
26B Wiring
27 Dielectric layer
27A Dielectric
28 Reflective film
31 Drive circuit
32 Drive circuit
35 Control circuit
123A Metal pattern
124A Metal pattern

1.-6. (canceled)

7. A metasurface comprising:
a first substrate;
a plurality of resonant cells arranged on a first main surface of the first substrate, each of the plurality of resonant cells including a dielectric having a variable dielectric constant and a pair of metal patterns sandwiching the dielectric, each of the plurality of resonant cells having a resonant frequency that changes according to the dielectric constant, and each of the plurality of resonant cells reflecting electromagnetic waves having a frequency corresponding to the resonant frequency; and
a reflective film formed on a second main surface of the first substrate opposite to the first main surface, the reflective film reflecting electromagnetic waves that are not reflected by the plurality of resonant cells and that are transmitted through the first substrate.

8. The metasurface according to claim 7,
wherein the pair of metal patterns are formed in a shape in which parts of the pair of metal patterns overlap when viewed from a thickness direction of the first substrate,
the dielectric is sandwiched between overlapping portions of the pair of metal patterns, and
the pair of metal patterns and the dielectric form a single resonant structure in which the part constitutes a capacitive component.

9. The metasurface according to claim 7, further comprising a second substrate facing the first main surface of the first substrate and having one of the pair of metal patterns formed on a surface facing the first main surface,
wherein the other of the metal patterns is formed on the first main surface, and
the dielectric is a part of a liquid crystal layer sealed between the first substrate and the second substrate.

10. The metasurface according to claim 9, wherein the first substrate and the second substrate are transparent, and the reflective film is formed in a transparent or mesh shape.

11. The metasurface according to claim 7, further comprising:
a first wiring connected to one of the pair of metal patterns, and
a second wiring connected to the other of the pair of metal patterns,
wherein the first wiring and the second wiring are formed of a material having a higher resistance than each of the pair of metal patterns.

12. A reflection system comprising:
a metasurface comprising:
a first substrate;
a plurality of resonant cells arranged on a first main surface of the first substrate, each of the plurality of resonant cells including a dielectric having a variable dielectric constant and a pair of metal patterns sandwiching the dielectric, each of the plurality of resonant cells having a resonant frequency that changes according to the dielectric constant, and each of the plurality of resonant cells reflecting electromagnetic waves having a frequency corresponding to the resonant frequency; and
a reflective film formed on a second main surface of the first substrate opposite to the first main surface, the reflective film reflecting electromagnetic waves that are not reflected by the plurality of resonant cells and that are transmitted through the first substrate; and
a control circuit that controls the dielectric constant for each of a predetermined number of resonant cells among the plurality of resonant cells and controls a phase distribution of electromagnetic waves in a specific frequency band reflected by the metasurface.

13. The reflection system according to claim 12,
wherein the pair of metal patterns are formed in a shape in which parts of the pair of metal patterns overlap when viewed from a thickness direction of the first substrate,
the dielectric is sandwiched between overlapping portions of the pair of metal patterns, and
the pair of metal patterns and the dielectric form a single resonant structure in which the part constitutes a capacitive component.

14. The reflection system according to claim 12, further comprising a second substrate facing the first main surface of the first substrate and having one of the pair of metal patterns formed on a surface facing the first main surface,
wherein the other of the metal patterns is formed on the first main surface, and
the dielectric is a part of a liquid crystal layer sealed between the first substrate and the second substrate.

15. The reflection system according to claim 14, wherein the first substrate and the second substrate are transparent, and the reflective film is formed in a transparent or mesh shape.

16. The reflection system according to claim 12, further comprising:
a first wiring connected to one of the pair of metal patterns, and
a second wiring connected to the other of the pair of metal patterns,
wherein the first wiring and the second wiring are formed of a material having a higher resistance than each of the pair of metal patterns.

17. The reflection system according to claim 12, wherein the specific frequency band is in a range of 3 GHz to 3 THz.

18. The reflection system according to claim 12, wherein the control circuit refers to voltage data that defines an applied voltage to each of the resonant cells and applies the applied voltage defined by the voltage data to each of the resonant cells.

19. A method, comprising:
providing a metasurface including a first substrate, a plurality of resonant cells arranged on a first main surface of the first substrate, each of the plurality of resonant cells including a dielectric having a variable dielectric constant and a pair of metal patterns sandwiching the dielectric, each of the plurality of resonant cells having a resonant frequency that changes according to the dielectric constant, and each of the plurality of resonant cells reflecting electromagnetic waves having a frequency corresponding to the resonant frequency, and a reflective film formed on a second main surface of the first substrate opposite to the first main surface, the reflective film reflecting electromagnetic waves that are not reflected by the plurality of resonant cells and that are transmitted through the first substrate;
controlling the dielectric constant for each of a predetermined number of resonant cells among the plurality of resonant cells; and
controlling a phase distribution of electromagnetic waves in a specific frequency band reflected by the metasurface.

20. The method according to claim 19,
wherein the pair of metal patterns are formed in a shape in which parts of the pair of metal patterns overlap when viewed from a thickness direction of the first substrate,
the dielectric is sandwiched between overlapping portions of the pair of metal patterns, and
the pair of metal patterns and the dielectric form a single resonant structure in which the overlapping portions constitute a capacitive component.

21. The method according to claim 19, further comprising providing a second substrate facing the first main surface of the first substrate and having one of the pair of metal patterns formed on a surface facing the first main surface,
wherein the other of the metal patterns is formed on the first main surface, and
the dielectric is a part of a liquid crystal layer sealed between the first substrate and the second substrate.

22. The method according to claim 19, wherein controlling the dielectric constant comprises referring to voltage data that defines an applied voltage to each of the resonant cells and applying the applied voltage defined by the voltage data to each of the resonant cells.

23. The method according to claim 19, wherein the specific frequency band is in a range of 3 GHz to 3 THz.
